(19) United States
(12) Patent Application Publication
(10) Pub. No.: US 2026/0101130 A1
(43) Pub. Date: Apr. 9, 2026

(54) Automatic Sound Level Reduction for Conversation Enhancement

(71) Applicant: Panasonic Automotive Systems America, LLC, Peachtree City, GA (US)

(72) Inventor: CHRISTOPHER LEE SULLIVAN, FARMINGTON HILLS, MI (US)

(21) Appl. No.: 19/348,725

(22) Filed: Oct. 2, 2025

Related U.S. Application Data
(60) Provisional application No. 63/703,485, filed on Oct. 4, 2024.

(51) Int. Cl. H04R 1/00; G10L 25/84

(52) U.S. Cl. CPC H04R 1/00; G10L 25/84; H04R 2430/01; H04R 2499/13

(57) ABSTRACT

A sound volume control arrangement for a motor vehicle includes a source of audio content producing an audio signal. A loudspeaker receives the audio signal and produces audible sounds based on the audio signal. An audio processor detects whether a human conversation is occurring within the motor vehicle and, in response to detecting the human conversation, reduces a volume at which the loudspeaker produces the audible sounds based on the audio signal.

### CROSS-REFERENCE TO RELATED APPLICATIONS

This application claims benefit of U.S. Provisional Application No. 63/703,485, filed on Oct. 4, 2024, the disclosure of which is hereby incorporated by reference in its entirety for all purposes.

### FIELD OF THE INVENTION

The disclosure relates to controlling the sound volume level of an infotainment system in a motor vehicle.

### BACKGROUND OF THE INVENTION

Holding a conversation in a motor vehicle can be difficult when there is loud music or other media content playing over the sound system. Often, occupants will manually turn down the volume (e.g., loudness) level of the vehicle's sound system in order to talk to each other, but this is not always a good solution. One problem is that sound system controls are often accessible only by front row occupants, so conversation cannot be easily initiated by a rear seat passenger. Another problem is that having to manually adjust sound system volume can be a distraction to the driver.

### SUMMARY

The present invention may provide one or more microphones in a vehicle which pick up a mixture of sounds, including background noise, audio playback from the vehicle's sound system, and the speech of one or more occupants. A digital signal processing system may be applied to reduce the level of background noise and audio playback from the microphone signal(s), leaving only the occupants' speech.

Another digital signal processing system may be applied to the microphone signal(s) to detect when speech is present, which indicates that the occupants are trying to have a conversation. When conversation is detected, the inventive system may automatically reduce the volume of the vehicle's audio playback system to improve speech audibility and intelligibility for the conversing occupants. When the conversation ends and speech is no longer detected in the microphone signal(s), the proposed system will automatically increase audio playback volume back to its original level.

As used herein, the term “conversation” indicates that at least one person is talking. It is not necessary that multiple people speak for there to be a conversation.

In one embodiment, one or more microphones detect the presence of speech in a vehicle and reduce sound system volume accordingly. Thus, the invention may improve speech intelligibility by reducing the level of competing sound system playback.

In another embodiment, an in-car communication (ICC) system amplifies the detected speech signals through the vehicle's sound system to further improve speech intelligibility. The ICC system may use microphones in the vehicle to pick up speech and amplify the speech through the vehicle's sound system to improve intelligibility in the presence of noise. The ICC may increase the level of speech in the vehicle in order to overcome the level of existing background sounds.

In yet another embodiment, a subsystem detects which occupants in the vehicle are trying to communicate, and then reduces sound system volume selectively for only those occupants. As an example, assume that there are four occupants in a two-row vehicle, and the driver is trying to have a conversation with the front passenger. The level of the sound system volume may be reduced only for the front speakers nearest to the driver and front passenger, while leaving the rear speaker volume levels alone. The ICC system of the immediately preceding paragraph may be added to this embodiment to provide selective volume adjustment. More generally, an ICC system may be added to any embodiment of the invention that lacks an ICC system in order to improve speech intelligibility in a vehicle.

The invention may improve speech intelligibility by reducing the level of competing sound system playback. This may be a better solution than increasing the volume levels of speech through an ICC system when audio playback levels are already loud.

In one embodiment, the invention comprises a sound volume control arrangement for a motor vehicle, including a source of audio content producing an audio signal. A loudspeaker is communicatively coupled to the source of audio content and receives the audio signal and produces audible sounds based on the audio signal. Detecting means detects a human conversation within the motor vehicle and, in response to detecting the human conversation, reduces a volume at which the loudspeaker produces the audible sounds based on the audio signal.

In another embodiment, the invention comprises a sound volume control method for a motor vehicle, including producing an audio signal. Audible sounds are produced based on the audio signal. A human conversation within the motor vehicle is detected. In response to detecting the human conversation, a volume at which the audible sounds based on the audio signal are produced is reduced.

In yet another embodiment, the invention comprises a sound volume control arrangement for a motor vehicle, including a source of audio content producing an audio signal. A loudspeaker receives the audio signal and produces audible sounds based on the audio signal. A microphone detects sounds within a passenger compartment of the motor vehicle and produces a microphone signal based thereon. An audio processor receives the microphone signal and determines based on the microphone signal whether a human conversation is occurring within the motor vehicle. A sound system processor is communicatively coupled to the audio processor and to the loudspeaker. The sound system processor reduces a volume at which the loudspeaker produces the audible sounds. The reducing of the volume is in response to the audio processor determining that the human conversation is occurring.

### BRIEF DESCRIPTION OF THE DRAWINGS

A better understanding of the present invention will be had upon reference to the following description in conjunction with the accompanying drawings.

FIG. 1 is a block diagram of one embodiment of a sound volume control arrangement of the present invention.

FIG. 2 is a block diagram of another embodiment of a sound volume control arrangement of the present invention.

FIG. 3 is a block diagram of yet another embodiment of a sound volume control arrangement of the present invention.

FIG. 4 is a flow chart of one embodiment of a sound volume control method of the present invention for a motor vehicle.

### DETAILED DESCRIPTION OF THE PREFERRED EMBODIMENTS

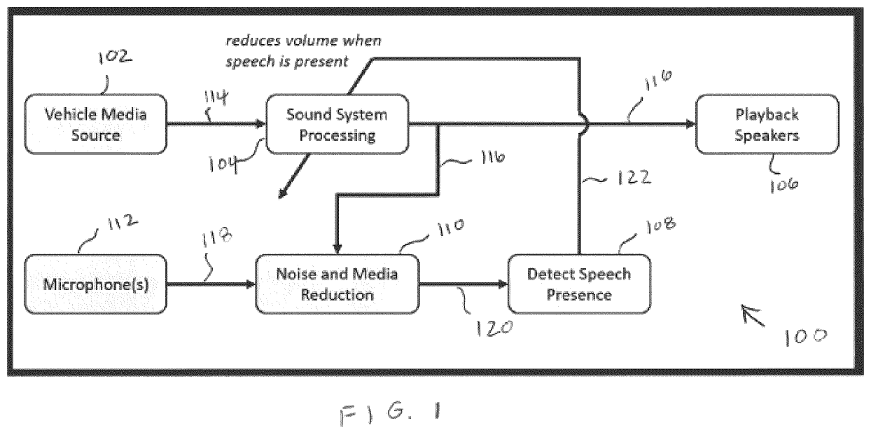

FIG. 1 illustrates one embodiment of a sound volume control arrangement 100 of the present invention, including a vehicle media content source 102, a sound system processor 104, playback loudspeakers 106, a speech presence detector 108, a noise and media content reduction block 110, and a microphone 112.

During use, vehicle media content source 102 produces an audio content signal 114 that may include recorded music content, for example. Sound system processor 104 receives signal 114 and transmits another audio content signal 116 that may be identical to signal 114 when there is no conversation going on. However, if it is determined that there is conversation going on in the vehicle, as described in more detail below, then audio content signal 116 may be a reduced-volume version of audio content signal 114.

Microphone 112 may pick up or detect any sounds within the passenger compartment of the vehicle and may produce a microphone signal 118 based on the detected sounds. Microphone signal 118 and audio content signal 116 are both received by noise and media content reduction block 110 where the audible content produced by content source 102 may be removed from microphone signal 118 to thereby produce a speech microphone signal 120.

Speech presence detector 108 receives and analyzes speech microphone signal 120 to determine whether a conversation is occurring in the vehicle. If it is determined that a conversation is occurring in the vehicle, then a volume reduction signal 122 is sent by speech presence detector 108. Volume reduction signal 122 is transmitted to and received by sound system processor 104, which then produces an audio content signal 116 that is a version of audio content signal 114 with reduced volume. If, however, it is determined that no conversation is occurring in the vehicle, then no volume reduction signal 122 is sent by speech presence detector 108. Audio content signal 116 then may be identical or substantially identical to audio content signal 114. Regardless of whether audio content signal 116 is volume-reduced or not, audio content signal 116 is converted into an audible sound by playback loudspeakers 106.

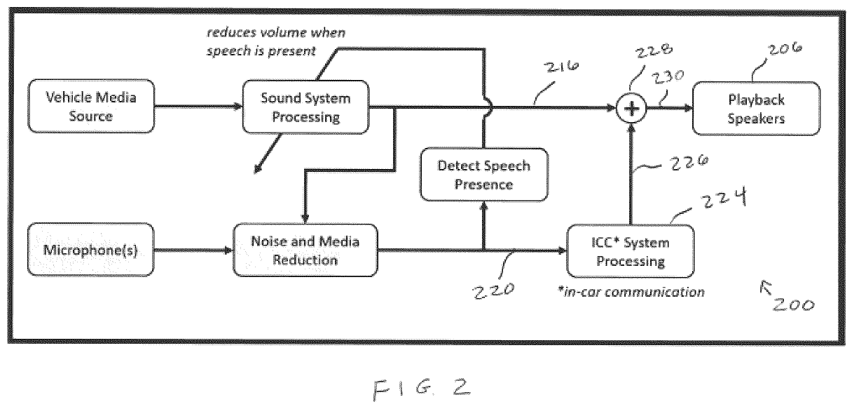

FIG. 2 illustrates another embodiment of a sound volume control arrangement 200 of the present invention. Arrangement 200 may be substantially similar to arrangement 100, except that arrangement 200 further includes an in-car communication (ICC) system processor 224 which receives speech microphone signal 220. Whatever speech is present in speech microphone signal 220 is represented in an ICC signal 226 produced by processor 224. ICC signal 226 may be added to an audio content signal 216 by a mixer 228 to produce an audio content with speech signal 230 that is converted into an audible sound by playback loudspeakers 206. Other features of arrangement 200 are substantially similar to those of arrangement 100, and thus are not described in detail herein in order to avoid needless repetition.

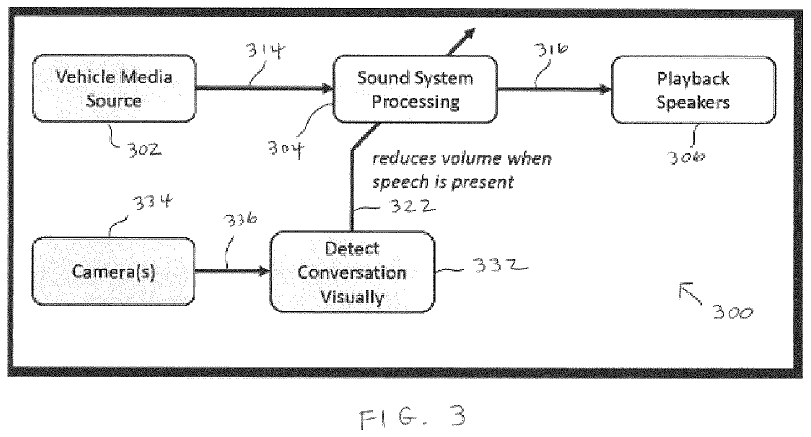

FIG. 3 illustrates yet another embodiment of a sound volume control arrangement 300 of the present invention, including a vehicle media content source 302, a sound system processor 304, playback loudspeakers 306, a visual conversation detector 332, and cameras 334.

During use, vehicle media content source 302 produces an audio content signal 314 that may include recorded music content, for example. Sound system processor 304 receives signal 314 and transmits another audio content signal 316 that may be identical to signal 314 when there is no conversation going on. However, if it is determined that there is conversation going on in the vehicle, as described in more detail below, then audio content signal 316 may be a reduced-volume version of audio content signal 314.

Cameras 334 may capture images of the mouths of any human passengers within the passenger compartment of the vehicle and may produce video signals 336 based on the captured images. Video signals 336 are received by visual conversation detector 332 which analyzes video signals 336 to determine whether a conversation is occurring in the vehicle. For example, if video signals show that at least one occupant's lips are moving in a way that is indicative of speech, then it may be determined that a conversation is occurring. If it is determined that a conversation is occurring in the vehicle, then a volume reduction signal 322 is sent by visual conversation detector 332. Volume reduction signal 322 is transmitted to and received by sound system processor 304, which then produces an audio content signal 316 that is a version of audio content signal 314 with reduced volume. If, however, it is determined that no conversation is occurring in the vehicle, then no volume reduction signal 322 is sent by visual conversation detector 332. Audio content signal 316 then may be identical or substantially identical to audio content signal 314. Regardless of whether audio content signal 316 is volume-reduced or not, audio content signal 316 is converted into an audible sound by playback loudspeakers 306.

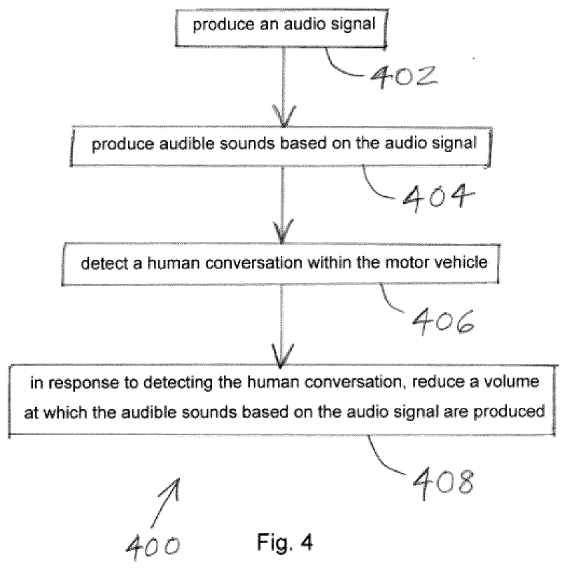

FIG. 4 illustrates one embodiment of a sound volume control method 400 of the present invention for a motor vehicle. In a first step 402, an audio signal is produced. For example, vehicle media content source 102 produces an audio content signal 114 that may include recorded music content. Sound system processor 104 receives signal 114 and transmits another audio content signal 116 that may be identical to signal 114 when there is no conversation going on.

Next, in step 404, audible sounds are produced based on the audio signal. For example, audio content signal 116 is converted into an audible sound by playback loudspeakers 106.

In a next step 406, a human conversation within the motor vehicle is detected. For example, microphone 112 may pick up or detect any sounds within the passenger compartment of the vehicle and may produce a microphone signal 118 based on the detected sounds. Microphone signal 118 and audio content signal 116 are both received by noise and media content reduction block 110 where the audible content produced by content source 102 may be removed from microphone signal 118 to thereby produce a speech microphone signal 120. Speech presence detector 108 receives and analyzes speech microphone signal 120 to determine whether a conversation is occurring in the vehicle.

In a final step 408, in response to detecting the human conversation, a volume at which the audible sounds based on the audio signal are produced is reduced. For example, if it is determined that a conversation is occurring in the vehicle, then a volume reduction signal 122 is sent by speech presence detector 108. Volume reduction signal 122 is transmitted to and received by sound system processor 104, which then produces an audio content signal 116 that is a version of audio content signal 114 with reduced volume.

The invention may be implemented by a set of digital signal processing systems, but it is also possible to implement the speech detection and volume adjustment stages with analog circuitry.

Instead of microphones to detect the presence of conversation in the vehicle, it is possible to use cameras to watch for mouth movements of the occupants. Such a configuration may support embodiments in which the level of competing sound system playback is decreased.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A sound volume control arrangement for a motor vehicle, the arrangement comprising:
a source of audio content configured to produce an audio signal;
a loudspeaker configured to receive the audio signal and produce audible sounds based on the audio signal; and
means for detecting a human conversation within the motor vehicle and, in response to detecting the human conversation, reducing a volume at which the loudspeaker produces the audible sounds based on the audio signal.

2. The sound volume control arrangement of claim 1 wherein the detecting means includes a microphone configured to detect sounds in a passenger compartment of the motor vehicle and produce a raw microphone signal based on the detected sounds.

3. The sound volume control arrangement of claim 2 wherein the detecting means includes an electronic noise and media content reduction device configured to:
receive the audio signal and the raw microphone signal; and
produce a speech microphone signal based on the audio signal and the raw microphone signal, the speech microphone signal being indicative of sounds in the passenger compartment that are not due to the audio signal.

4. The sound volume control arrangement of claim 3 further comprising an in-car communication (ICC) system processor configured to:
receive the speech microphone signal and produce an ICC signal indicative of the speech present in the speech microphone signal; and
transmit the ICC signal to the loudspeaker for producing audible sounds based on the ICC signal and thereby increase a loudness of speech sounds in the passenger compartment of the motor vehicle.

5. The sound volume control arrangement of claim 3 wherein the detecting means includes a speech presence detector configured to:
receive the speech microphone signal;
determine, based on the speech microphone signal, whether the human conversation is occurring in the passenger compartment; and
produce a volume reduction signal if it is determined that the human conversation is occurring in the passenger compartment.

6. The sound volume control arrangement of claim 5 wherein the audio signal comprises a first audio signal, the detecting means including a sound system processor configured to:
receive the first audio signal and the volume reduction signal; and
transmit to the loudspeaker a second audio signal that is substantially similar to the first audio signal except that the second audio signal has a lower volume than the first audio signal.

7. The sound volume control arrangement of claim 1 wherein the detecting means includes a camera configured to capture images of a mouth of an occupant of the motor vehicle.

8. The sound volume control arrangement of claim 7 wherein the detecting means includes a visual conversation detector configured to receive the captured images and determine, based on the captured images, whether the human conversation within the motor vehicle is occurring.

9. A sound volume control method for a motor vehicle, the method comprising:
producing an audio signal;
producing audible sounds based on the audio signal;
detecting a human conversation within the motor vehicle; and
in response to detecting the human conversation, reducing a volume at which the audible sounds based on the audio signal are produced.

10. The sound volume control method of claim 9 further comprising:
detecting sounds in a passenger compartment of the motor vehicle; and
producing a raw microphone signal based on the detected sounds.

11. The sound volume method of claim 10 further comprising producing a speech microphone signal based on the audio signal and the raw microphone signal, the speech microphone signal being indicative of sounds in the passenger compartment that are not due to the audio signal.

12. The sound volume control method of claim 11 further comprising:
producing an ICC signal indicative of the speech present in the speech microphone signal; and
transmitting the ICC signal to the loudspeaker for producing audible sounds based on the ICC signal and thereby increase a loudness of speech sounds in the passenger compartment of the motor vehicle.

13. The sound volume control method of claim 11 further comprising:
determining, based on the speech microphone signal, whether the human conversation is occurring in the passenger compartment; and
producing a volume reduction signal if it is determined that the human conversation is occurring in the passenger compartment.

14. The sound volume control method of claim 13 wherein the audio signal comprises a first audio signal, the method further comprising producing a second audio signal that is substantially similar to the first audio signal except that the second audio signal is produced at a lower volume than the first audio signal.

15. The sound volume control method of claim 9 wherein the detecting step includes capturing images of lips of an occupant of the motor vehicle.

16. The sound volume control method of claim 15 wherein the detecting step includes determining, based on the captured images, whether the human conversation within the motor vehicle is occurring.

17. A sound volume control arrangement for a motor vehicle, the arrangement comprising:
a source of audio content configured to produce an audio signal;
a loudspeaker configured to receive the audio signal and produce audible sounds based on the audio signal;
a microphone configured for detecting sounds within a passenger compartment of the motor vehicle and producing a microphone signal based thereon;
an audio processor configured to receive the microphone signal and determine based on the microphone signal whether a human conversation is occurring within the motor vehicle; and
a sound system processor communicatively coupled to the audio processor and to the loudspeaker, the sound system processor being configured to reduce a volume at which the loudspeaker produces the audible sounds, the reducing of the volume being in response to the audio processor determining that the human conversation is occurring.

18. The sound volume control arrangement of claim 17 wherein the microphone signal comprises a raw microphone signal, the audio processor including an electronic noise and media content reduction device configured to:
receive the audio signal and the raw microphone signal; and
produce a speech microphone signal based on the audio signal and the raw microphone signal, the speech microphone signal being indicative of sounds in the passenger compartment that are not due to the audio signal.

19. The sound volume control arrangement of claim 18 further comprising an in-car communication (ICC) system processor configured to:
receive the speech microphone signal and produce an ICC signal indicative of the speech present in the speech microphone signal; and
transmit the ICC signal to the loudspeaker for producing audible sounds based on the ICC signal and thereby increase a loudness of speech sounds in the passenger compartment of the motor vehicle.

20. The sound volume control arrangement of claim 17 further comprising a camera configured to capture images of a face of an occupant of the motor vehicle such that it can be determined based on the images whether the occupant is speaking.
